(19) United States
(12) Patent Application Publication
(10) Pub. No.: US 2008/0250936 A1
(43) Pub. Date: Oct. 16, 2008

(54) Machine for Percolating Beverage from Powdered Material in a Container

(76) Inventor: Virginio Cortese, Torino (IT)

Correspondence Address: LADAS & PARRY LLP, 26 WEST 61ST STREET, NEW YORK, NY, 10023, US

(21) Appl. No.: 11/631,913

(22) PCT Filed: Jul. 12, 2005
(86) PCT No.: PCT/EP2005/053334

§ 371 Date: Jan. 22, 2008

(30) Foreign Application Priority Data
Jul. 13, 2004 (IT) TO2004A 000479

(51) Int. Cl. A47J 31/40

(52) U.S. Cl. 99/295

(57) ABSTRACT

A machine for percolating a beverage from powdered material in a container, the machine being substantially vertical, and having a pressurized-hot-water dispensing assembly movable to and from an engaged position connected in fluidtight manner to a percolating assembly, which houses a container and is defined by a rotor rotating about a substantially horizontal, fixed axis of rotation, and having a number of peripheral percolating cups, each of which can be set selectively to an infusion position, in which the cup is positioned upwards facing the dispensing assembly, by rotating the rotor in response to the dispensing assembly withdrawing from the engaged position connected to the percolating assembly.

### TECHNICAL FIELD

The present invention relates to a machine for percolating a beverage from powdered material in a container.

### BACKGROUND ART

More specifically, the present invention relates to a machine for percolating a beverage from powdered material in a container, having a vertical axis and of the type disclosed in EP-A-1369069, that is a machine comprising at least a percolating cup for housing the container, the percolating cup being movable to and from an infusion position coaxial with the vertical axis; a dispensing device communicating with the percolating cup for dispensing the beverage; a lid arranged above the percolating cup in the infusion position for moving, in relation to the percolating cup, between a raised open position and a lowered closed position coaxial to the vertical axis for respectively opening and closing the percolating cup; coupling means to couple the lid in the lowered closed position to the percolating cup; a pressurized-hot-water dispensing assembly accommodated inside the lid and comprising an outlet water sprinkler and water-operated pushing means which, when the lid is coupled by said coupling means to the percolating cup, are adapted to move the sprinkler along the lid and the vertical axis to an engaged position where the sprinkler is coupled to the percolating cup in a watertight manner and the lid is locked to the percolating cup.

Though the machine according to the present invention is suitable for percolating any type of beverage made by feeding pressurized hot water through powdered material in a container, specific reference is made in the following description, purely by way of example, to a machine for making a coffee beverage using a container containing a measure of ground coffee.

### DISCLOSURE OF INVENTION

It is an object of the present invention to improve a machine of the type described above, to permit automatic unloading of the used container when using the machine to make the next beverage, and before loading a fresh container onto the machine.

According to the present invention, there is provided a machine for percolating a beverage from powdered material in a container, as claimed in claim 1 and, preferably, in any one of the following Claims depending directly or indirectly on claim 1.

### BRIEF DESCRIPTION OF THE DRAWINGS

The invention will now be described by way of examples with reference to the accompanying drawings, in which:

FIG. 1 is a perspective view of a first preferred embodiment of the machine according to the present invention;

FIG. 2 shows an axial section of the FIG. 1 machine;

FIGS. 3 and 4 show smaller-scale side views, with parts removed for clarity, of the FIG. 1 machine in respective different operating positions;

FIGS. 5 and 6 show front views of the FIG. 1 machine in the FIGS. 3 and 4 positions respectively;

FIGS. 7 and 8 show rear views of the FIG. 1 machine in the FIGS. 4 and 3 positions respectively;

FIG. 9 shows an axial section of a second preferred embodiment of the machine according to the present invention;

FIG. 10 shows an axial section of a third preferred embodiment of the machine according to the present invention.

### BEST MODE FOR CARRYING OUT THE INVENTION

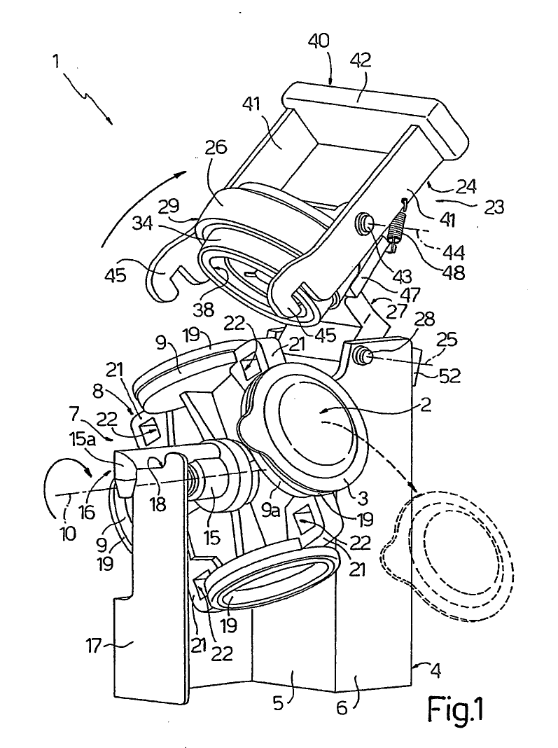

Number 1 in FIG. 1 indicates as a whole a machine for percolating a coffee beverage from a measure of ground coffee inside a container, which is defined, in the example shown, by a standard wafer 2 defined by a closed casing made of permeable material and having a peripheral outer annular flange 3.

Machine 1 comprises a frame 4 defined by a parallelepiped-shaped box body, in turn defined by a substantially vertical front wall 5, and by two parallel vertical lateral walls 6 perpendicular to front wall 5.

Machine 1 also comprises a percolating assembly 7 fitted to and projecting from front wall 5, and in turn comprising a rotor 8 having, along its outer periphery, four percolating cups 9 arranged in opposite pairs and each for at least partly housing a wafer 2. As shown in FIG. 1, rotor 8 is mounted for rotation about an axis 10 perpendicular to front wall 5, so as to move cups 9 in steps (as explained later on) along a circular path coaxial with axis 10, and selectively set each cup 9 to an infusion position, in which cup 9 is positioned with its concavity facing upwards, and is coaxial with a substantially vertical axis 11 perpendicular to axis 10.

As shown in FIG. 2, rotor 8 is fitted to the central portion of a shaft 12 coaxial with axis 10 and comprising a rear portion inserted in rotary manner inside a sleeve 13, which is fitted, coaxially with axis 10, through a hole in front wall 5, and is connected integrally to front wall 5. At the end projecting rearwards of sleeve 13, shaft 12 is fitted with a substantially circular flange 14, which, together with a lock ring fitted to shaft 12 at the front end of sleeve 13, provides for locking shaft 12 axially with respect to sleeve 13.

Shaft 12 comprises a front portion projecting frontwards of rotor 8 and engaging in rotary and axially-fixed manner a sleeve 15 of a coffee dispensing device 16. In addition to sleeve 15, dispensing device 16 also comprises a percolating spout 15a positioned eccentrically with respect to sleeve 15 and projecting from sleeve 15 in a direction parallel to axis 10. As shown in FIGS. 4 and 6, sleeve 15 is maintained angularly fixed by a bracket 17, which is connected rigidly to frame 4 and comprises a front wall parallel to front wall 5 and having, on its free top edge, a V-shaped cavity 18 engaged transversely by percolating spout 15a.

Each cup 9 houses a wafer cup 19 defined by a perforated cup-shaped body of a depth equal to roughly half the thickness of a wafer 2, and having an L-shaped outer edge fitted removably to the free edge of cup 9, and which, in use, defines a supporting surface for flange 3 of a wafer 2 housed inside wafer cup 19.

Each cup 9 also comprises a respective outflow conduit 20 formed through rotor 8 and communicating with percolating spout 15a (FIG. 2) when relative cup 9 is set to the infusion position described above.

Rotor 8 comprises four appendixes 21, each of which extends, crosswise to axis 10, between a respective pair of adjacent cups 9, and has a square central slot 22 formed through appendix 21 in a direction parallel to axis 10.

As shown in FIG. 1, machine 1 comprises a hinged lid 23 hinged to frame 4 to oscillate, by means of a manual actuating device 24 and about an axis 25 crosswise to axis 10, between a raised open position (FIGS. 1, 3, 5, 8) and a lowered closed position (FIGS. 2, 4, 6, 7) to respectively open and close whichever of cups 9 is in the infusion position.

With reference to FIG. 2, lid 23 comprises a cup-shaped body 26 positioned with its concavity facing percolating assembly 7, and defining one arm of a rocker arm 27 hinged to lateral walls 6 of frame 4 by a pin 28 coaxial with axis 25.

Cup-shaped body 26 defines the outer sleeve of a hydraulic cylinder 29 comprising, in addition to cup-shaped body 26, a piston 30, which is mounted to slide along cup-shaped body 26, and, together with cup-shaped body 26, defines a variable-volume chamber 31 closed in fluidtight manner by an annular seal 32, and communicating, along a feed conduit 33, with a known boiler (not shown), fixed to frame 4, to receive pressurized hot water from the boiler.

At the end facing percolating assembly 7, piston 30 is fitted rigidly with a concave sprinkler 34, which, together with piston 30, defines a pressurized-hot-water dispensing assembly. Sprinkler 34 receives pressurized hot water from chamber 31 through piston 30, and, when lid 23 is in the lowered position, is moved by piston 30 to and from an engaged position, connected in fluidtight manner to wafer cup 19 (FIG. 2) housed in the cup 9 in the infusion position, to define, with wafer cup 19, a percolating chamber 35.

Pressurized-hot-water flow from chamber 31 to sprinkler 34 is regulated by a known one-way valve 36 housed inside a hole 37 through the centre of piston 30, and calibrated to open when the pressure in chamber 31 and feed conduit 33 reaches a given value.

Sprinkler 34 is defined by a cylindrical body of substantially the same diameter as cups 9, and having, on a bottom surface facing percolating assembly 7, a cavity 38 defining the top half-chamber of percolating chamber 35, and of a depth equal to roughly half the thickness of a wafer 2. Cavity 38 communicates with chamber 31 through hole 37 and through a hole 39 formed through sprinkler 34 and coaxial with hole 37.

As shown in FIGS. 1 and 2, manual actuating device 24 of lid 23 comprises a handle 40, in turn comprising two rocker arms 41 located on opposite sides of hydraulic cylinder 29, connected to each other at respective ends by a cross member 42, and hinged to a pin 43, integral with cup-shaped body 26, to oscillate about an axis 44 parallel to axis 25 and crosswise to axis 10. More specifically, each rocker arm 41 comprises a first arm interposed between cross member 42 and pin 43; and a second arm, which extends from pin 43 towards percolating assembly 7, is aligned with the respective first arm, and has a U-shaped end hook 45 positioned with its concavity facing frame 4, and which, in use, engages a respective slot 22 to define, together with the other hook 45, a bolt coupling device 46.

As shown in FIG. 1, when lid 23 is in the raised open position, handle 40 is secured in position, with cross member 42 at the top and with rocker arms 41 substantially parallel to a longitudinal axis of hydraulic cylinder 29, by a stop device comprising a rib 47 carried by lid 23 and projecting alongside one of rocker arms 41 and radially with respect to hydraulic cylinder 29 to prevent handle 40 from dropping down backwards when lid 23 is moved into the raised open position.

The stop device also comprises a spring 48, which extends between rib 47 and the rocker arm 41 on the same side as rib 47, and, when lid 23 is moved into the raised open position, holds rocker arm 41 in contact with rib 47 to prevent hooks 45 from striking the top of relative appendixes 21 when lid 23 is moved into the lowered closed position.

Machine 1 also comprises a transmission 49 for unloading a used wafer 2 automatically from relative wafer cup 19 after the coffee is made. As explained in more detail later on, transmission 49 comprises a ratchet mechanism for converting rotation of lid 23, from the lowered closed position to the raised open position, into rotation of rotor 8 about axis 10 by an angle equal to the angular spacing of cups 9 about axis 10.

As shown in FIGS. 4 and 7, transmission 49 comprises a cage 50 defined by flange 14, by a plate 14a facing flange 14 and coaxial with axis 10, and by four pins 51 parallel to one another and to axis 10, equally spaced about axis 10, and connecting flange 14 to plate 14a.

Transmission 49 also comprises a pawl 52, which is hinged, by a pin 53 parallel to axis 25, to the free end of a second arm of rocker arm 27 opposite to cup-shaped body 26, and is defined by an elastic lever extending from rocker arm 27 towards axis 10, and having, on its free end, a recess 54 with its concavity facing downwards.

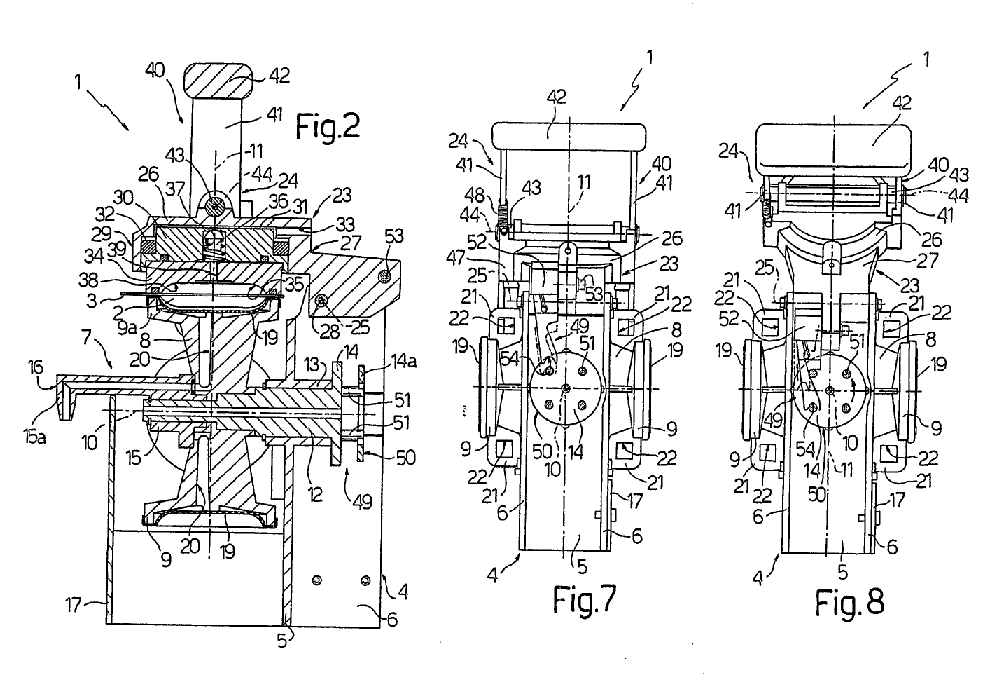

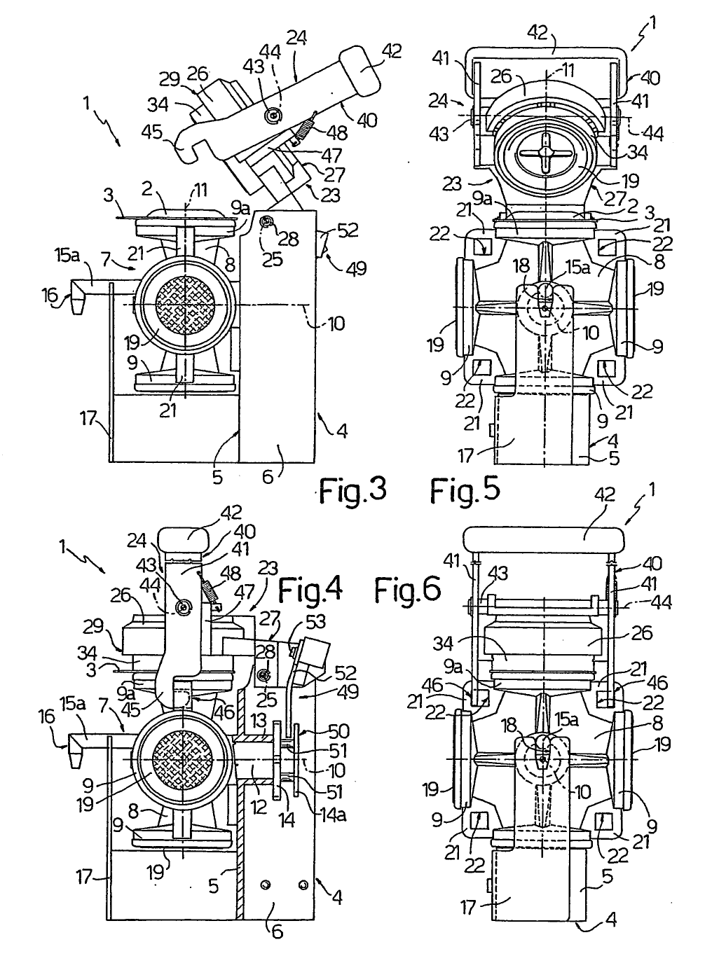

Operation of machine 1 will now be described as of the FIGS. 3 and 5 operating position, in which lid 23 is in the raised open position, and a wafer 2 has been loaded inside wafer cup 19 of whichever of cups 9 is in the infusion position, and which is hereinafter referred to as cup 9a.

By pulling cross member 42 of handle 40, the user rotates lid 23 (anticlockwise in FIG. 3) about axis 25 into the lowered closed position, in which sprinkler 34 and piston 30 are coaxial with axis 11.

At this point, by exerting further pull on cross member 42, in opposition to spring 48, the user rotates rocker arms 41 about axis 44, so that hooks 45 engage slots 22 on either side of cup 9a to couple lid 23 in the lowered closed position to cup 9a.

In this connection it is worth pointing out that, during insertion of hooks 45 inside slots 22, no real pressure is applied since hooks 45, when coupling lid 23 to cup 9a, do not generate any axial pressure between lid 23 and cup 9a, but only fix lid 23 in the lowered closed position.

When the user turns on machine 1 by means of an external control, pressurized hot water is pumped along feed conduit 33 into chamber 31, which, on expanding, moves piston 30 down and so moves sprinkler 34 into the engaged position mentioned above, in which sprinkler 34 presses flange 3 of wafer 2 in fluidtight manner against the outer edge of wafer cup 19 (FIGS. 2, 4, 6) and locks lid 23 in the lowered closed position to cup 9a. In other words, the axial locking pressure to lock lid 23 to cup 9a is not imparted by hooks 45 engaging slots 22, but by hooks 45 resisting, inside slots 22, to the axial pressure applied by piston 30.

When percolating chamber 35 is closed, the pressure inside chamber 31 increases rapidly to open valve 36, so that pressurized hot water flows through holes 37 and 39 into percolating chamber 35 to produce the coffee, which then flows out along outflow conduit 20 and percolating spout 15a.

When the user presses a stop button (not shown), pressurized-hot-water supply is cut off and valve 36 closes. If, at this point, the user pushes cross member 42 away in a direction substantially crosswise to axis 11, hooks 45 release respective slots 22 to restore lid 23 to the raised open position.

As shown in FIGS. 7 and 8, as lid 23 rotates about axis 25 into the raised open position, the arm of rocker arm 27 opposite to cup-shaped body 26 moves down gradually to push down pawl 52, so that recess 54 transversely engages one of the two pins 51 on the same side of axis 10 as pawl 52 (dash line in FIG. 7). At this point, by virtue of recess 54 engaging relative pin 51, further downward movement of pawl 52 rotates cage 50, and therefore shaft 12 and rotor 8, about axis 10 (anticlockwise in FIG. 8), so that cup 9a moves down and the used wafer 2 drops out (FIG. 1)

By the time lid 23 reaches the raised open position, rotor 8 has rotated 90°, and another cup 9 is set to the infusion position, ready to receive another wafer 2.

It should be pointed out that, as lid 23 moves from the raised open position to the lowered closed position, rotor 8 remains stationary in the angular positioned assumed at the end of the previous operating cycle. That is, when moved upwards, pawl 52 releases pin 51 and, sliding on the lateral surface of the pin 51 above the one engaged previously, moves elastically over to the opposite side of axis 10 (dash line in FIG. 8) and back into the initial position of non-interference with pins 51 (continuous line in FIG. 7).

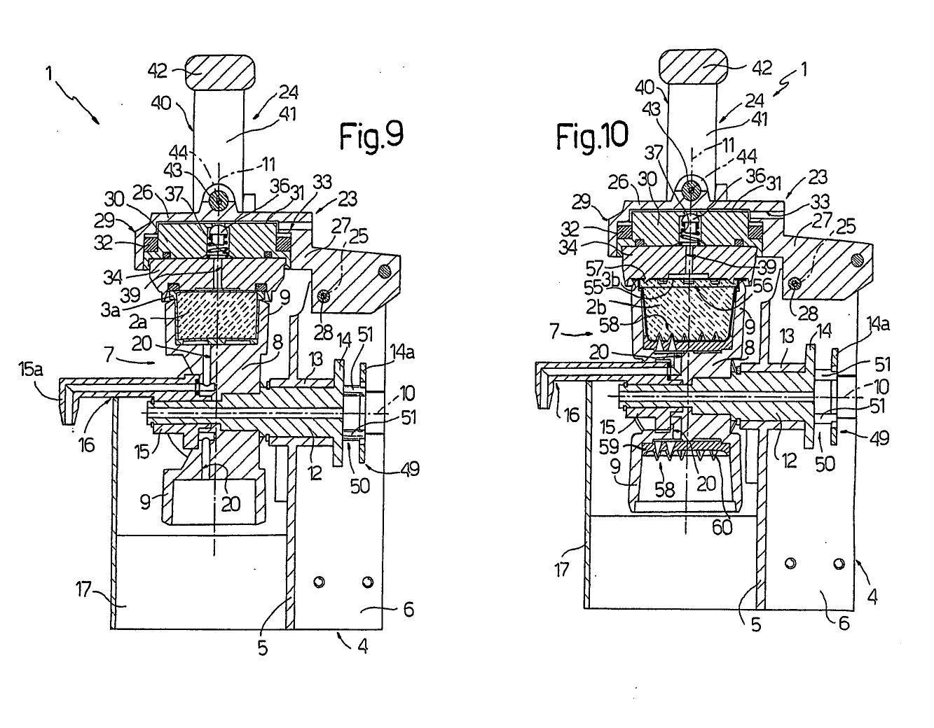

As shown in FIG. 9, machine 1 can also be used to make coffee from a container defined by a rigid perforated capsule 2a, i.e. a capsule bounded laterally by a cylindrical wall and closed at the ends by two perforated walls, one of which comprises an outer annular end flange 3a.

In this case, each cup 9 has no wafer cup 19, and is of a depth approximately equal to but no smaller than the height of capsule 2a minus the thickness of outer annular flange 3a, and therefore such as to house capsule 2a completely, with a small amount of axial clearance, and with outer annular flange 3a resting on the free edge of cup 9.

In the FIG. 10 variation, the container used is a sealed capsule 2b defined by a cup-shaped body made of thermoplastic material and closed in fluidtight manner by a sealing wall 55, normally of metal foil, the periphery of which is connected integrally to the outer surface of an outer annular flange 3b of the cup-shaped body.

In this case, sprinkler 34 comprises a piercing device 56 for piercing sealing wall 55 when lid 23 is in the lowered closed position, and which comprises a number of known rectangular-based projections 57 extending downwards from sprinkler 34 and equally spaced, about a longitudinal axis of sprinkler 34, in a circle slightly smaller in radius than outer annular flange 3b of sealed capsule 2b.

Each cup 9 also houses a respective piercing device 58 comprising a plate 59 resting on the bottom wall of cup 9, and a number of known hollow extraction needles 60 extending upwards from plate 59 and which, in use, pierce a bottom wall of sealed capsule 2b deformed towards plate 59 when pressurized hot water is fed into sealed capsule 2b.

It should be pointed out that, when machine 1 employs a container defined by a rigid perforated capsule 2a or a sealed capsule 2b, the container, unlike wafer 2, is not unloaded by 90° rotation of rotor 8, owing to the depth of cup 9 preventing the container from sliding automatically out of cup 9 when its longitudinal axis is positioned horizontally. Capsule 2a, 2b is nevertheless unloaded automatically when cup 9 housing the used capsule 2a, 2b is positioned with its concavity facing downwards by rotating rotor 8 through 180°, i.e. through two successive steps, each corresponding to one operating cycle of machine 1.

1. A machine for percolating a beverage from powdered material in a container (2; 2a; 2b), the machine (1) having a vertical axis (11) and comprising at least a percolating cup (9) for housing the container (2; 2a; 2b), the percolating cup (9) being movable to and from an infusion position coaxial with the vertical axis (11); a dispensing device (16) communicating with the percolating cup (9) for dispensing the beverage; a lid (23) arranged above the percolating cup (9) in the infusion position for moving, in relation to the percolating cup (9), between a raised open position and a lowered closed position coaxial to the vertical axis (11) for respectively opening and closing the percolating cup (9); coupling means (46) to couple the lid (23) in the lowered closed position to the percolating cup (9); a pressurized-hot-water dispensing assembly (30, 34) accommodated inside the lid (23) and comprising an outlet water sprinkler (34) and water-operated pushing means (30) which, when the lid (23) is coupled by said coupling means (46) to the percolating cup (9), are adapted to move the sprinkler (34) along the lid (23) and the vertical axis (11) to an engaged position where the sprinkler (34) is coupled to the percolating cup (9) in a watertight manner and the lid (23) is locked to the percolating cup (9); the machine (1) being characterized by comprising a rotor (8) mounted for rotation about a horizontal axis (10) and driven by the lid (23) being moved away from the lowered closed position; the percolating cup (9) being arranged radially on the periphery of the rotor (8); and the coupling means (46) comprising bolt means (45) carried by the lid (23) and bolt receiving means (22) provided on the rotor and engaged by the bolt means (45) when the lid (23) is in the lowered closed position.

2. A machine as claimed in claim 1, wherein the rotor (8) comprises a number of percolating cups (9) equally spaced, with a given angular spacing, about its horizontal axis (10) of rotation; the rotor (8) selectively setting each cup (9) to the infusion position, in which the cup (9) is positioned upwards facing the lid (23); and transmission means (49) being interposed between the lid (23) and the rotor (8) to rotate the rotor (8) by one step, equal to said angular spacing, in response to the lid (23) being moved away from the lowered closed position.

3. A machine as claimed in claim 2, wherein the lid (23) comprises a hollow outer body (26), and the water-operated pushing means (30) comprise a piston (30) mounted to slide along the hollow outer body (26) and defining, with the hollow outer body (26), a variable-volume chamber (31) communicating with a pressurized-hot-water supply (33); the sprinkler (34) being integral with the piston (30) and communicating with the variable-volume chamber (31); and non-return valve means (36) being interposed between the variable-volume chamber (31) and the sprinkler (34).

4. A machine as claimed in claim 1, wherein the lid (23) is mounted for oscillating, between said raised open position and said lowered closed position, about a substantially horizontal oscillation axis (25) crosswise to said axis (10) of rotation.

5. A machine as claimed in claim 3, wherein said hollow outer body (26) defines a first arm of a rocker arm (27) hinged to said frame (4) to oscillate about said oscillation axis (25); the rocker arm (27) comprising a second arm, and said transmission means (49) being interposed between said second arm and the rotor (8).

6. A machine as claimed in claim 1, wherein the bolt receiving means (22) comprise at least one seat (22) formed in the rotor (8); and the bolt means (46) comprise at least one hook (45) fitted to the lid (23) to oscillate, about an axis (44) parallel to said oscillation axis (25), to and from a position engaging said seat (22).

7. A machine as claimed in claim 4, and comprising a handle (40) for hand-rotating said lid (23) about said oscillation axis (25); said bolt means (46) forming part of said handle (40).

8. A machine as claimed in claim 7, wherein said handle (40) comprises two rocker arms (41) fitted to the lid (23), on opposite sides of the lid (23), to oscillate, with respect to the lid (23), about an axis (44) parallel to said oscillation axis (25); said bolt means (46) being carried by said rocker arms (41).

9. A machine as claimed in claim 8, and comprising, for each said rocker arm (41), a seat (22) formed in the rotor (8); said bolt means (46) comprising, for each said rocker arm (41), a hook (45) formed on an end portion of the relative rocker arm (41) and movable with the rocker arm (41) to and from a position engaging said seat (22).

10. A machine as claimed in claim 2, and comprising a shaft (12) coaxial with said axis (10) of rotation and fitted with said rotor (8); said transmission means (49) comprising a cage (50) rotating with the shaft (12) about the axis (10) of rotation, and having a number of pins (51), which are integral with and parallel to the shaft (12), are equally spaced about the axis (10) of rotation, and are each associated with a respective cup (9); and a ratchet member (52) carried by the lid (23) and movable with the lid (23) to selectively engage one of said pins (51) at a time, and to rotate the cage (50) about the axis (10) of rotation by an angle equal to said angular spacing, in response to the lid (23) being moved from the lowered closed position to the raised open position.

11. A machine as claimed in claim 2, wherein the cups (9) are four in number, and said angular spacing is an angle of 90°.

12. A machine as claimed in claim 2, wherein the each cup (9) comprises a respective outflow conduit (20) formed through the rotor (8) and communicating with said dispensing device (16) when the relative cup (9) is in the infusion position.

13. A machine for percolating a beverage from powdered material in a container (2; 2a; 2b), the machine (1) being substantially vertical, and comprising a frame (4); a percolating assembly (7) for housing a said container (2; 2a; 2b); and a pressurized-hot-water dispensing assembly (30, 34) which is rotatable about a horizontal axis (25) and is displaceable transversely to the horizontal axis (25) to move to and from an engaged position connected in fluidtight manner to the percolating assembly (7); and being characterized in that the percolating assembly (7) comprises a rotor (8) fitted to the frame (4) to rotate in steps, with respect to the frame (4), about a fixed, substantially horizontal axis (10) of rotation, and a dispensing device (16) for dispensing said beverage; the rotor (8) comprising a number of percolating cups (9) equally spaced, with a given angular spacing, about the fixed said axis (10) of rotation, each cup (9) housing a said container (2; 2a; 2b) and being selectively connectable to the dispensing device (16); the rotor (8) selectively setting each cup (9) to an infusion position, in which the cup (9) is positioned upwards facing the dispensing assembly (30, 34); and transmission means (49) being interposed between the dispensing assembly (30, 34) and the rotor (8) to rotate the rotor (8) by one step, equal to said angular spacing, in response to the dispensing assembly (30, 34) withdrawing from said engaged position.

14. A machine as claimed in claim 13, and comprising a lid (23) mounted to move between a raised open position and a lowered closed position respectively opening and closing whichever of the cups (9) is in said infusion position; said dispensing assembly (30, 34) forming part of the lid (23); and said transmission means (49) rotating the rotor (8) by said step in response to the lid (23) moving into said raised open position.

15. A machine as claimed in claim 14, wherein the lid (23) comprises a hollow outer body (26) and said dispensing assembly (30, 34), which in turn comprises a piston (30) mounted to slide along the hollow outer body (26) and defining, with the hollow outer body (26), a variable-volume chamber (31) communicating with a pressurized-hot-water supply (33); a sprinkler (34) integral with the piston (30) and communicating with the variable-volume chamber (31); and non-return valve means (36) interposed between the variable-volume chamber (31) and the sprinkler (34); the sprinkler (34) being set to the fluidtight said engaged position by the piston (30) when the lid (23) is in said lowered closed position.

16. A machine as claimed in claim 14, wherein said lid (23) is hinged to the frame (4) to oscillate, with respect to the frame (4) and between said raised open position and said lowered closed position, about a substantially horizontal oscillation axis (25) crosswise to said axis (10) of rotation.
